(19) United States
(12) Patent Application Publication
(10) Pub. No.: US 2026/0258854 A1
(43) Pub. Date: Sep. 3, 2026

(54) POWER TRANSMISSION DEVICE

(71) Applicants: JATCO LTD, Fuij-shi, Shizuoka (JP); Nissan Motor Co., Ltd., Yokohama-shi, Kanagawa (JP)

(72) Inventors: Kenji KOJIMA, Atsugi, Kanagawa (JP); Akira HIGASHIYAMA, Isehara, Kanagawa (JP); Kenji SAKAKIBARA, Sagamihara, Kanagawa (JP)

(21) Appl. No.: 18/846,961

(22) PCT Filed: Mar. 23, 2023
(86) PCT No.: PCT/JP2023/011614

§ 371 Date: Sep. 13, 2024

(30) Foreign Application Priority Data
Mar. 23, 2022 (JP) 2022-047611

(51) Int. Cl. F16H 9/18

(52) U.S. Cl. CPC F16H 9/18

(57) ABSTRACT

A power transmission device includes a variator having a primary pulley and a secondary pulley; and a control valve configured to supply a working oil to the primary pulley and the secondary pulley. The control valve has a plurality of pressure regulating valves with valve bodies that move in a horizontal direction, the pressure regulating valves including a first pressure regulating valve configured to adjust a supply pressure to the primary pully and a second pressure regulating valve configured to adjust a supply pressure to the secondary pully. The control valve is oriented such that the pressure regulating valves are arranged in a vertical direction. An axis of rotation of the secondary pulley is located above an axis of rotation of the primary pulley in the vertical direction. The second pressure regulating valve is located above a first pressure regulating valve.

### CROSS-REFERENCE TO RELATED APPLICATIONS

This application is a U.S. national stage application of International Application No. PCT/JP 2023/011614, filed on Mar. 23, 2023. This application also claims priority to Japanese Patent Application No 2022-047611, filed on Mar. 23, 2022.

### BACKGROUND

### Technical Field

The present invention relates to a power transmission device.

Background Information Japanese Patent Laid-Open Publication No. 2019-173943 discloses a vehicle drive device in which an oil pressure control device is arranged in an upright posture along the vertical direction.

### SUMMARY

In this vehicle drive device, an oil pressure control device is provided on a side section inside a case that houses a drive transmission mechanism. When viewed from the horizontal line direction, the oil pressure control device is arranged in a positional relationship overlapping with the drive transmission mechanism.

Here, when the oil pressure control device is arranged below the drive transmission mechanism in the vertical line direction, the components of the drive transmission mechanism are arranged in a positional relationship overlapping with the oil pressure control device without significantly overlapping with other components when viewed from the vertical line direction.

On the other hand, when the oil pressure control device is arranged in an upright posture, some components of the drive transmission mechanism are arranged in a positional relationship overlapping with the oil pressure control device while overlapping with other components when viewed from the horizontal line direction.

Here, the oil pressure control device (control valve) regulates the pressure of oil for operating the components of the drive transmission mechanism. Pressure-regulated oil is supplied to each component via oil passages provided in the case.

Therefore, when the oil pressure control device is arranged in an upright posture, the layout (routing) of the oil passages in the case becomes complex.

Accordingly, there is a demand to minimize the degree of complication of the oil passage layout when the oil pressure control device is arranged in an upright posture along the vertical direction, that is, vertically oriented.

An aspect of the present disclosure is a power transmission device comprising a variator having a primary pulley and a secondary pulley, and a control valve that supplies a working oil to the primary pulley and the secondary pulley, wherein the control valve has multiple pressure regulating valves with valve bodies that move in a horizontal direction, the control valve is disposed oriented such that the pressure regulating valves are arranged in a vertical direction, the axis of rotation of the secondary pulley is located above the axis of rotation of the primary pulley in the vertical direction, and a second pressure regulating valve that adjusts supply pressure to the secondary pulley is located above a first pressure regulating valve that adjusts supply pressure to the primary pulley in the vertical direction.

According to one aspect of the present invention, it is possible to minimize the complexity of the oil path layout.

### BRIEF DESCRIPTION OF THE DRAWINGS

Referring now to the attached drawings which form a part of this original disclosure. FIG. 1 is a schematic diagram showing a general configuration of the power transmission device.

FIG. 2 is a schematic diagram showing the case as viewed from the second cover side.

FIG. 3 is a schematic diagram showing the case as viewed from the first cover side.

FIG. 4 is a diagram showing the housing section as viewed from the front of the vehicle.

FIG. 5 is a diagram illustrating an example of the oil pressure control circuit inside the control valve and the oil supply path to the variator.

FIG. 6 is a diagram illustrating the movement of oil during operation of the power transmission device and the height of the oil OL collected in the second chamber.

FIG. 7 is a diagram illustrating a dummy cover.

FIG. 8 is a diagram illustrating the relationship between the oil path inside the case and the positions of the primary pressure regulating valve and the secondary pressure regulating valve.

FIG. 9 is a diagram illustrating a power transmission device according to a modified example.

### DETAILED DESCRIPTION

First, definitions of terminology in the present specification will be explained.

A power transmission device is a device having at least a power transmission mechanism, where the power transmission mechanism is, for example, at least one of a gear mechanism, a differential gear mechanism, or a reduction gear mechanism.

In the following embodiment, a case is illustrated in which a power transmission device 1 has a function for transmitting the output rotation of an engine, but the power transmission device 1 need only transmit the output rotation of at least one of an engine or a motor (rotating electrical machine).

“Overlaps as viewed from a prescribed direction” means that a plurality of elements are arranged in a prescribed direction, and means the same as “overlapping in a prescribed direction.” “Prescribed direction” is, for example, the axial direction, radial direction, direction of gravity, direction of travel of the vehicle, front-rear direction of the vehicle, etc.

If a plurality of elements (parts, sections, etc.) are shown arranged in a prescribed direction in the drawings, it may be assumed that there is text in the description in the specification indicating that the plurality of elements overlap when viewed in the prescribed direction.

“Not overlapping when viewed in a prescribed direction” and “offset when viewed in a prescribed direction” mean that a plurality of elements are not arranged in the prescribed direction, and mean the same as “not overlapping in a prescribed direction” and “offset in a prescribed direction.” “Prescribed direction” is, for example, the axial direction, radial direction, direction of gravity, direction of travel of the vehicle (vehicle forward travel direction, vehicle rearward travel direction), etc.

If a plurality of elements (parts, sections, etc.) are shown not arranged in a prescribed direction in the drawings, it may be assumed that there is text in the description in the specification indicating that the plurality of elements do not overlap when viewed in the prescribed direction.

“As viewed from a prescribed direction, a first element (part, section, etc.) is located between a second element (part, section, etc.) and a third element (part, section, etc.)” means that when viewed from the prescribed direction, the first element can be seen between the second element and the third element. The “prescribed direction” is, for example, the axial direction, radial direction, direction of gravity, direction of travel of the vehicle (forward movement direction of the vehicle, rearward movement direction of the vehicle), etc.

For example, if the second element, the first element, and the third element are arranged in that order in the axial direction, then the first element is located between the second element and the third element when viewed from the radial direction. If the first element is shown between the second element and the third element as viewed from a prescribed direction in the drawings, it may be assumed that there is text in the description in the specification describing the first element between the second element and the third element as viewed from the prescribed direction.

When two elements (parts, sections, etc.) overlap as viewed from the axial direction, the two elements are coaxial.

“Axial direction” means the axial direction of the axis of rotation of a part making up the device. “Radial direction” means a direction orthogonally intersecting the axis of rotation of the part making up the device. The part is, for example, a motor, a gear mechanism, a differential gear mechanism, or the like.

“Upright” with reference to the control valve means that in the case of a control valve having a basic configuration with a separation plate sandwiched between valve bodies, the valve bodies of the control valve are stacked in the horizontal line direction based on the state of installation of the power transmission device in the vehicle. The “horizontal line direction” here does not mean the horizontal line direction in the strict sense, but also includes cases in which the direction of stacking is at an angle relative to the horizontal line.

Further, “upright” with respect to the control valve means that the control valve is arranged with the plurality of pressure regulating valves inside the control valve aligned in the direction of a vertical line VL based on the state of installation of the power transmission device in the vehicle.

“The plurality of pressure regulating valves aligned in the direction of a vertical line VL” means that the regulating valves inside the control valve are arranged spaced out in the direction of the vertical line VL.

In this case, the plurality of pressure regulating valves need not be strictly arranged in single file in the direction of the vertical line VL.

For example, if the plurality of valve bodies are stacked to form the control valve, the following is possible. Namely, the plurality of pressure regulating valves may be arranged in the direction of the vertical line VL with shifted positions in the direction of stacking of the valve bodies in the upright control valve.

Further, as viewed from the axial direction of the valve bodies provided on the pressure regulating valves (the direction of forward and backward movement), the plurality of pressure regulating valves need not be arranged with gaps in between in the direction of the vertical line VL.

As viewed from the axial direction of the valve bodies provided with the pressure regulating valves (the direction of forward and backward movement), the plurality of pressure regulating valves need not be adjacent in the direction of the vertical line VL.

Hence, if, for example, the pressure regulating valves arranged in the direction of the vertical line VL are arranged with shifted positions in the stacking direction (horizontal line direction) of the valve bodies, then cases are also included in which, as viewed from the stacking direction, the pressure regulating valves that are adjacent in the direction of the vertical line VL are provided in a partially overlapping positional relationship.

Further, that the control valve is “upright” means that the plurality of pressure regulating valves inside the control valve are arranged in the direction of movement of the valve bodies (spool valves) provided in the pressure regulating valves aligned in the horizontal line direction.

The direction of movement of the valve bodies (spool valves) in this case is not limited to the horizontal line direction in the strict sense. The direction of movement of the valve bodies (spool valves) in this case is a direction along an axis of rotation X of the power transmission device. In this case, the direction of the axis of rotation X and the sliding direction of the valve bodies (spool valves) are the same.

An embodiment of the present disclosure is described below.

FIG. 1 is a schematic diagram illustrating the arrangement of a power transmission device 1.

As shown in FIG. 1, a housing HS of the power transmission device 1 is configured by a case 6, a first cover 7, a second cover 8, and a third cover 9.

The interior of the housing HS accommodates a torque converter T/C, a forward-reverse switching mechanism 2, a variator 3, a reduction mechanism 4, a differential drive device 5, an electronic oil pump EOP, a mechanical oil pump MOP, a control valve CV, etc.

The torque converter T/C, the forward-reverse switching mechanism 2, the variator 3, the reduction mechanism 4, the differential device 5 are components of the power transmission mechanism in the invention.

In the power transmission device 1 mounted in the vehicle V, output rotation of an engine ENG (the drive source) is input into the forward-reverse switching mechanism 2 via the torque converter T/C.

The rotation input to the forward-reverse switching mechanism 2 is forward rotation or reverse rotation and is input to a primary pulley 31 of the variator 3.

In the variator 3, changing the winding radius of a belt 30 in the primary pulley 31 and a secondary pulley 32 causes the rotation input to the primary pulley 31 to be shifted at a desired gear ratio and output by an output shaft 33 of the secondary pulley 32.

Output rotation of the secondary pulley 32 is input via the reduction mechanism 4 into the differential drive mechanism 5 (differential gear mechanism) and is then transmitted to drive wheels WH, WH via left and right drive shafts 55A, 55B.

The reduction mechanism 4 has an output gear 41, an idler gear 42, a reduction gear 43, and a final gear 45.

The output gear 41 rotates together with the output shaft 33 of the secondary pulley 32.

The idler gear 42 meshes with the output gear 41 in a manner allowing transmission of rotation. The idler gear 42 is spline-fitted to an idler shaft 44. The idler gear 42 rotates together with the idler shaft 44. The idler shaft 44 is provided with the reduction gear 43 that has a smaller radius than the idler gear 42. The reduction gear 43 meshes with the final gear 45 that is fixed to the outer circumference of a differential case 50 of the differential device 5 in a manner allowing transmission of rotation.

In the power transmission device 1, the forward-reverse switching mechanism 2, the torque converter T/C, and the output shaft of the engine ENG are arranged coaxially (concentrically) along an axis of rotation X1 (first axis) of the primary pulley 31.

The output shaft 33 of the secondary pulley 32 and the output gear 41 are arranged coaxially along an axis of rotation X2 (second axis) of the secondary pulley 32.

The idler gear 42 and the reduction gear 43 are arranged coaxially along a common axis of rotation X3 (third axis).

The final gear 45 and the drive shafts 55A, 55B are arranged coaxially on a common axis of rotation X4 (fourth axis). In the power transmission device 1, the axes of rotation X1-X4 are set to have a positional relationship parallel to each other. In the following, these axes of rotation X1-X4 may, as needed, be referred to as the axis of rotation X of the power transmission device 1.

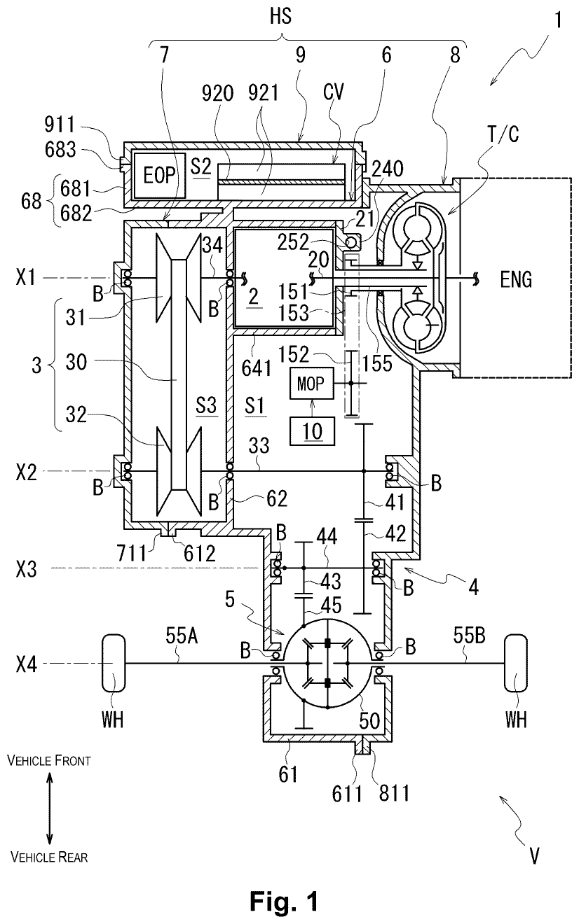

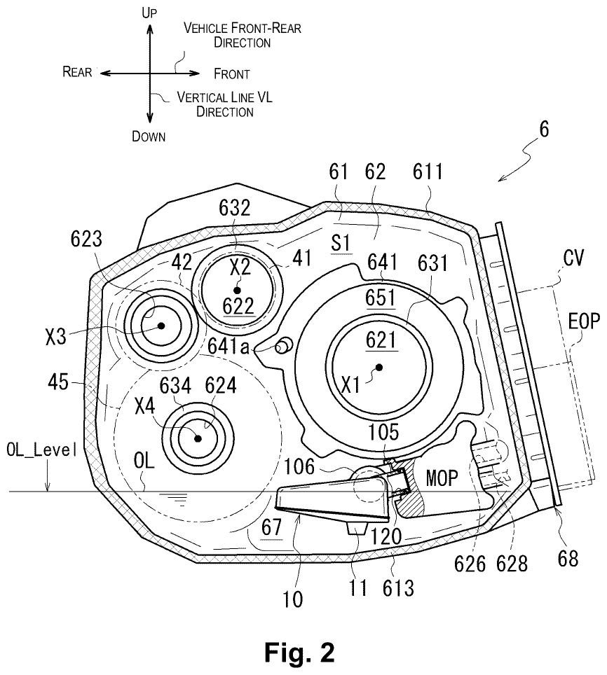

FIG. 2 is a schematic diagram illustrating the case 6 viewed from the second cover 8 side.

As shown in FIG. 2, the case 6 has a circumferential wall section 61 and a partition section 62. region

As shown in FIG. 1, the partition section 62 divides the space inside the circumferential wall section 61 into two along the direction of the axis of rotation X1. One side of the partition section 62 in the direction of the axis of rotation X1 forms the first chamber S1, and the other side forms the third chamber S3.

In the case 6, an opening on the side of the first chamber S1 is sealed by the second cover 8 (torque converter cover), forming the closed first chamber S1. An opening on the side of the third chamber S3 is sealed by the first cover 7 (side cover), forming the closed third chamber S3.

The first chamber S1 houses the forward-reverse switching mechanism 2, the reduction mechanism 4, and the differential device 5. The third chamber S3 houses the variator 3.

In the case 6, the housing section 68 that forms the second chamber S2 is attached to the outer circumference of the circumferential wall section 61 on the front side of the vehicle.

The housing section 68 is provided with an opening facing toward the front of the vehicle. The opening of the housing section 68 is sealed by the third cover 9, forming the closed second chamber S2.

The second chamber S2 houses the control valve CV and the electric oil pump EOP.

As shown in FIG. 2, inside the case 6, the partition section 62 is located inside a joining section 611.

The partition section 62 of the case 6 is provided within a range cutting across the axes of rotation (axes of rotation X1 to X4) of the power transmission mechanism. The partition section 62 is provided in a direction essentially orthogonal to the axes of rotation (axes of rotation X1 to X4).

The partition section 62 is provided with through-holes 621, 622, 624, and a support hole 623.

The through-hole 621 is formed around the axis of rotation X1. A cylindrical support wall section 631 surrounding the through-hole 621 and a circumferential wall section 641 surrounding the outer circumference of the cylindrical support wall section 631 with a space in between are provided in the surface of the partition section 62 facing the first chamber S1 (toward the viewer). The cylindrical support wall section 631 and the circumferential wall section 641 project toward the viewer in FIG. 2 (toward the second cover 8 in FIG. 1).

A region 651 between the support wall section 631 and the circumferential wall section 641 is a cylindrical space that houses the piston (not shown) of the forward-reverse switching mechanism 2, and friction plates (forward clutch, reverse brake).

The inner circumference of the support wall section 631 rotatably supports the input shaft 34 of the primary pulley 31 (see FIG. 1) via bearings B.

As shown in FIG. 2, the through-hole 622 is formed around the axis of rotation X2. In the power transmission device 1 mounted in the vehicle V, the axis of rotation X2 is positioned diagonally upward toward the rear of the vehicle when viewed from the axis of rotation X1.

A cylindrical support wall section 632 that surrounds the through-hole 622 is provided in the partition section 62 on the side of the first chamber S1 (toward the viewer). In FIG. 2, the support wall section 632 protrudes toward the viewer (the side of the second cover 8 in FIG. 1).

The inner circumference of the support wall section 632 rotatably supports the output shaft 33 of the secondary pulley 32 (see FIG. 1) via bearings B.

As shown in FIG. 2, the through-hole 624 is formed around the axis of rotation X4. In the power transmission device 1 mounted in the vehicle V, the axis of rotation X4 is positioned diagonally downward toward the rear of the vehicle when viewed from the axes of rotation X1 and X2.

A cylindrical support wall section 634 that surrounds the through-hole 624 is provided in the partition section 62 on the side of the first chamber S1 (toward the viewer. The inner circumference of the support wall section 634 rotatably supports the differential case 50 of the differential device 5 (see FIG. 1) via the bearings B.

As shown in FIG. 1, the final gear 45, which forms a ring shape when viewed from the direction of the axis of rotation X4, is fixed to the outer circumference of the differential case 50. The final gear 45 rotates around the axis of rotation X4 together with the differential case 50.

In the case 6, the region toward the front of the vehicle from the final gear 45, specifically the region below the arc-shaped circumferential wall section 641, serves as the housing section 67 for the strainer 10 and the mechanical oil pump MOP.

The housing section 67 is located in the lower part of the case 6 (housing HS).

Therefore, the housing section 67 collects the oil OL used for driving and cooling the components of the power transmission mechanism.

The housing section 67 is a closed-end space, and in FIG. 2, the partition section 62 forms the bottom wall on the side away from the viewer in the housing section 67.

In the housing section 67, the strainer 10 is provided with a suction port 11 for oil OL facing the bottom wall section 613 of the case 6.

A first connection part 105 of the strainer 10 is inserted into the connection port 120 on the side of the mechanical oil pump MOP (see FIG. 2). The second connection part 106 of the strainer 10 is connected to the oil path 626 inside the partition section 62. Therefore, the strainer 10 is supported at two points, the mechanical oil pump MOP and the partition section 62. The mechanical oil pump MOP is connected to the control valve CV via the oil path 628 inside the partition section 62.

Thus, the strainer 10 is connected to the control valve CV through the mechanical oil pump MOP and the oil path 628 inside the partition section 62. The strainer 10 is also connected to the electric oil pump EOP via the oil path 626 inside the partition section 62.

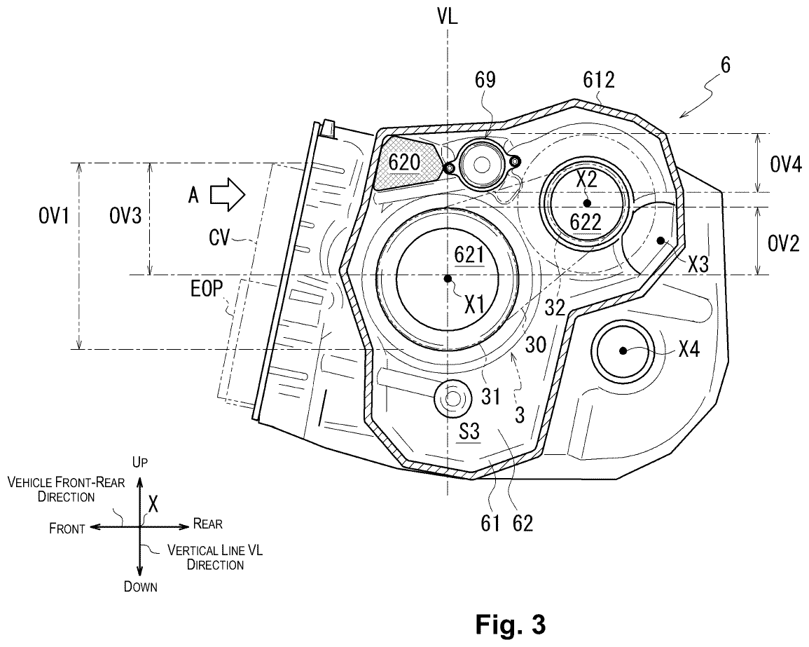

FIG. 3 is a plan view of the case 6 viewed from the side of the first cover 7. In FIG. 3, crosshatching is applied to the region of the opening 620.

As shown in FIG. 3, on the side of the first cover 7 of the case 6, the partition section 62 is located inside the circumferential wall section 61 that surrounds the third chamber S3. The end surface of the circumferential wall section 61 toward the viewer serves as the joining section 612 with the first cover 7. The joining section 612 surrounds the third chamber S3 around the entire circumference.

Inside the circumferential wall section 61, the opening 620 and the through-holes 621, 622 are provided in the partition section 62.

The opening 620 is provided near the circumferential wall section 61 near the front side of the vehicle, along the top edge of the circumferential wall section 61. Viewed from the opening 620, the oil filter 69 is provided toward the rear of the vehicle. The oil filter 69 is positioned adjacent to the opening 620. The oil filter 69 and the opening 620 are aligned in the horizontal line direction along the vehicle front-rear direction.

In the partition section 62, below the opening 620 and the oil filter 69, through-hole 621 is positioned. The through-hole 622 is positioned diagonally upward toward the rear of the vehicle when viewed from through-hole 621.

The opening 620 is positioned on the front side of the vehicle along the vertical line VL that passes through the center (axis of rotation X1) of through-hole 621. The oil filter 69 and through-hole 622 are positioned toward the rear of the vehicle relative to the vertical line VL.

The third chamber S3 is a housing chamber for the variator 3. The variator 3 has a primary pulley 31, a secondary pulley 32, and a belt 30 wound around the primary pulley 31 and the secondary pulley 32.

An input shaft 34 of the primary pulley 31 (see FIG. 1) passes through a through-hole 621. An output shaft 33 of the secondary pulley 32 (see FIG. 1) passes through a through-hole 622.

The primary pulley 31 is located below and toward the front of the vehicle as compared to the secondary pulley 32. As viewed from the primary pulley 31, a control valve CV, which is housed in the second chamber S2 (see FIG. 1), is located toward the front of the vehicle.

When viewed from the front of the vehicle (the side indicated by arrow A in the diagram), the control valve CV is provided in a positional relationship overlapping with the primary pulley 31 and the secondary pulley 32. That is, when viewed from the front of the vehicle, the control valve CV overlaps with the primary pulley 31 and the secondary pulley 32 in a height range OV1.

In the front-rear direction of the vehicle, the primary pulley 31 is located between the control valve CV and the secondary pulley 32.

Therefore, when viewed from the horizontal line direction along the front-rear direction of the vehicle, the secondary pulley 32 is in a positional relationship overlapping significantly with the primary pulley 31 and also overlapping with the control valve CV. That is, when viewed from the front of the vehicle, the secondary pulley 32 overlaps with the primary pulley 31 in a height range OV2. When viewed from the front of the vehicle, the secondary pulley 32 overlaps with the control valve CV in a height range OV3.

An opening 620 and an oil filter 69 are positioned between the control valve CV and the secondary pulley 32 in the forward and backward direction of the vehicle. Therefore, when viewed from the front of the vehicle, the secondary pulley 32 is also provided in a positional relationship overlapping with the opening 620 and the oil filter 69. That is, when viewed from the front of the vehicle, the secondary pulley 32 overlaps with the opening 620 and the oil filter 69 in a height range OV4.

Thus, the primary pulley 31, the opening 620, and the oil filter 69 are located between the secondary pulley 32 and the control valve CV.

As shown in FIG. 1, in the case 6, the housing section 68 is attached to the side surface toward the front of the vehicle.

The housing section 68 is provided with an opening facing the front of the vehicle. A wall section 682, which is the bottom wall of the housing section 68, is arranged in the direction along the axis of rotation X1. When viewed from the radial direction of the axis of rotation X1, the housing section 68 is formed in the direction of the axis of rotation X1, from the region of the circumferential wall section 61 of the case 6 to the side of the first cover 7.

A region of approximately half of the wall section 682 of the housing section 68 on the engine ENG side is integrated with the circumferential wall section 61. Approximately half of the opposite side of the wall section 682 is provided with a gap from the outer circumference of the first cover 7, extending from the circumferential wall section 61.

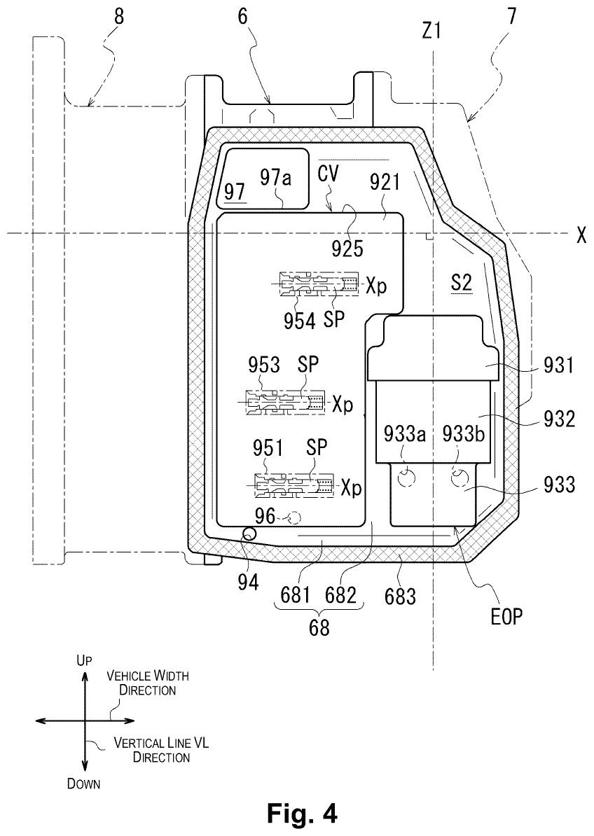

FIG. 4 is a view of the housing section 68 from the front of the vehicle. In FIG. 4, the second chamber S2, as viewed from the front of the vehicle, is shown schematically along with other components of the housing HS (the case 6, the first cover 7, the second cover 8). Additionally, crosshatching is applied to the region of the joining section 683 located toward the viewer to clarify the location thereof. Also, the appearances of the control valve CV and the electric oil pump EOP are shown schematically.

As shown in FIG. 4, when viewed from the front of the vehicle, the housing section 68 has a wall section 682 and a surrounding wall 681 that encompasses the entire outer circumference of the wall section 682. The end surface of the surrounding wall 681 on the side facing the viewer serves as the joining section 683 with the third cover 9.

As shown in FIG. 1, the joining section 683 is joined along the entire circumference with the joining section 911 on the third cover 9 side. The housing section 68 and the third cover 9 are connected by bolts not shown in the drawings, with the joining sections 683, 911 joined together.

As shown in FIG. 1, the second chamber S2 houses the control valve CV and the electric oil pump EOP.

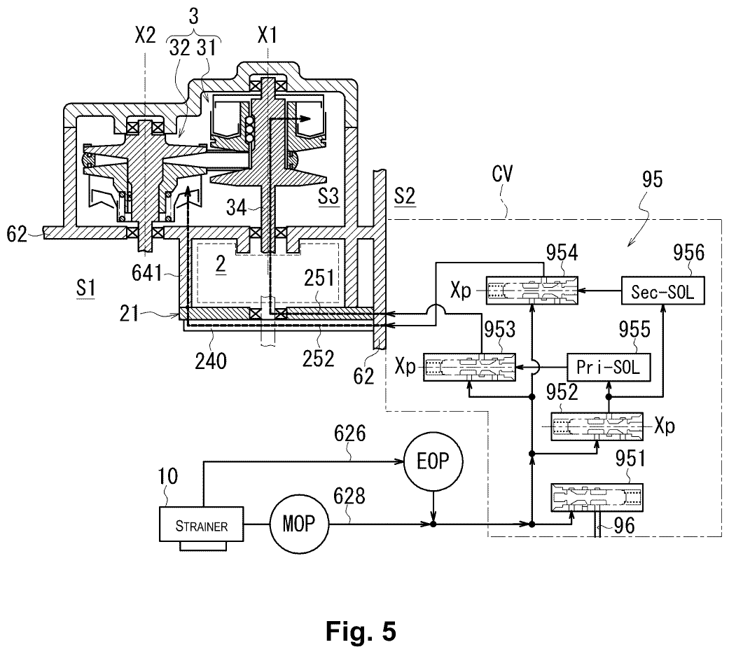

The control valve CV has a basic structure in which a separator plate 920 is sandwiched between valve bodies 921, 921. An oil pressure control circuit 95 (see FIG. 5) is formed inside the control valve CV. The oil pressure control circuit 95 is provided with pressure regulating valves (spool valves SP) that operate based on signal pressures generated by solenoids driven by commands from a control device (not shown in the drawings).

Inside the second chamber S2, the control valve CV is arranged upright with the stacking direction of the valve bodies 921, 921 aligned in the vehicle front-rear direction.

As shown in FIG. 4, in the second chamber S2, the control valve CV is arranged upright to meet the following conditions. (a) Multiple spool valves SP inside the control valve CV are aligned in the direction of the vertical line VL (vertical direction) based on the installation state of the power transmission device 1 in the vehicle V, and (b) the direction of advancement and retraction Xp of the spool valves SP is aligned in the horizontal line direction.

This ensures that the control valve CV is arranged upright in the second chamber S2 while the movement of the spool valves SP is not hindered. Therefore, the second chamber S2 is prevented from increasing in size in the vehicle front-rear direction.

Inside the second chamber S2, the control valve CV and the electric oil pump EOP are aligned in the direction of the axis of rotation X (left-right direction in FIG. 4). As shown in FIG. 1, when viewed from the front of the vehicle, the control valve CV is provided in a positional relationship overlapping with the first chamber S1. When viewed from the front of the vehicle, the electric oil pump EOP is provided in a positional relationship overlapping with the third chamber S3.

As shown in FIG. 4, the electric oil pump EOP has a basic configuration in which a control unit 931, a motor unit 932, and a pump unit 933 are aligned in series in the direction of an axis of rotation Z1 of the motor.

The electric oil pump EOP is provided such that the axis of rotation Z1 thereof is oriented orthogonal to the axis of rotation X of the power transmission device 1. In this state, the electric oil pump EOP is arranged upright with the pump unit 933 positioned at the very bottom of the second chamber S2.

An intake port 933a and a discharge port 933b of the pump unit 933 are located on the boundary side with the motor unit 932. The intake port 933a of the pump unit 933 is connected to the oil path 626. The discharge port 933b of the pump unit 933 is connected to the control valve CV via another oil path inside the case.

The control valve CV is provided with a discharge port 96 for the oil OL discharged from the pressure regulating valves.

Therefore, the excess oil OL discharged from the control valve CV is discharged into the second chamber S2 housing the control valve CV.

In the second chamber S2, a communication section 94 opens at the bottommost part of the region of the wall section 682 overlapping with the first chamber S1. The communication section 94 connects the first chamber S1 and the second chamber S2.

Further, an opening 97 is provided at the topmost part of the wall section 682. The opening 97 opens at a position overlapping with the first chamber S1 on the wall section 682.

A lower edge 97a of the opening 97 is positioned at approximately the same height as an upper edge 925 of the control valve CV.

Thus, the communication section 94 and the opening 97 each connect the second chamber S2 and the first chamber S1. Therefore, the second chamber S2 communicates with the first chamber S1 at the top and bottom in the vertical line VL direction based on the state of installation of the power transmission device 1 in the vehicle V.

FIG. 5 is a diagram illustrating an example of the oil pressure control circuit 95 inside the control valve CV and the supply path of the oil OL to the variator 3 (the primary pulley 31, the secondary pulley 32). The oil pressure control circuit 95 shows parts related to the regulation of the operating oil pressure of the variator 3 (the primary pulley 31, the secondary pulley 32).

As shown in FIG. 5, the power transmission device 1 is provided with one each of the mechanical oil pump (MOP) and the electric oil pump (EOP). These oil pumps (the mechanical oil pump MOP and the electric oil pump EOP) suction the oil OL collected in the lower part of the housing HS through the strainer 10. The suctioned oil OL is then pressurized and supplied to the oil pressure control circuit 95 inside the control valve CV.

In the following description, when there is no need to distinguish between the mechanical oil pump MOP and the electric oil pump EOP, the pump is simply referred to as “the oil pump OP.”

The oil pressure control circuit 95 inside the control valve CV regulates the operating oil pressure of the power transmission mechanism (such as the forward-reverse switching mechanism 2, variator 3, etc.) based on the oil pressure generated by the oil pump OP.

The line pressure regulating valve 951 adjusts the line pressure from the oil pressure generated by the oil pump OP by adjusting the amount of oil OL at the line pressure regulating valve 951.

The line pressure adjusted by the line pressure regulating valve 951 is supplied to a primary pressure regulating valve 953, a secondary pressure regulating valve 954, and a pilot pressure regulating valve 952. Note that the line pressure is also supplied to other pressure regulating valves provided in the oil pressure control circuit 95.

The pilot pressure regulating valve 952 adjusts the pilot pressure based on the line pressure. The pilot pressure adjusted by the pilot pressure regulating valve 952 is supplied to a primary solenoid 955 and a secondary solenoid 956.

The primary solenoid 955 and the secondary solenoid 956 operate based on commands from a control device (not shown in the drawings) and regulate the signal pressure supplied to the primary pressure regulating valve 953 and the secondary pressure regulating valve 954.

In the primary pressure regulating valve 953 and the secondary pressure regulating valve 954, the spool valves move in the axial direction (the Xp direction in the diagram) in response to the signal pressure.

When the spool valves move in the axial direction, the line pressure regulated by the line pressure regulating valve 951 is further regulated to a pressure corresponding to the position of the spool valves, and then supplied to the pressure chambers of the corresponding pulleys (the primary pulley 31, the secondary pulley 32).

The line pressure regulating valve 951 is located on the farthest upstream side (the oil pump OP side) within the oil pressure control circuit 95, where the oil pressure generated by the oil pump OP is first supplied.

When adjusting the line pressure from the oil pressure generated by the oil pump OP, a part of the oil produced by the oil pump OP is drained in the line pressure regulating valve 951.

The line pressure regulating valve 951 is provided inside the control valve CV. The control valve CV needs to be arranged so that the direction XP of advancement and retraction of the pressure regulating valves (spool valves) within the oil pressure control circuit 95 aligns in the horizontal line HL direction.

Therefore, the control valve CV is arranged upright inside the second chamber S2.

As shown in FIG. 4, in the control valve CV, the line pressure regulating valve 951, the primary pressure regulating valve 953, and the secondary pressure regulating valve 954 are arranged in this order from bottom to top.

The line pressure regulating valve 951 and the primary pressure regulating valve 953 are positioned on the side of the electric oil pump EOP, so that the pressure regulating valves (spool valves) are arranged in a direction aligning in the horizontal line direction.

The secondary pressure regulating valve 954 is positioned above the electric oil pump EOP, so that the pressure regulating valves (spool valves) are arranged in a direction aligning in the horizontal line direction.

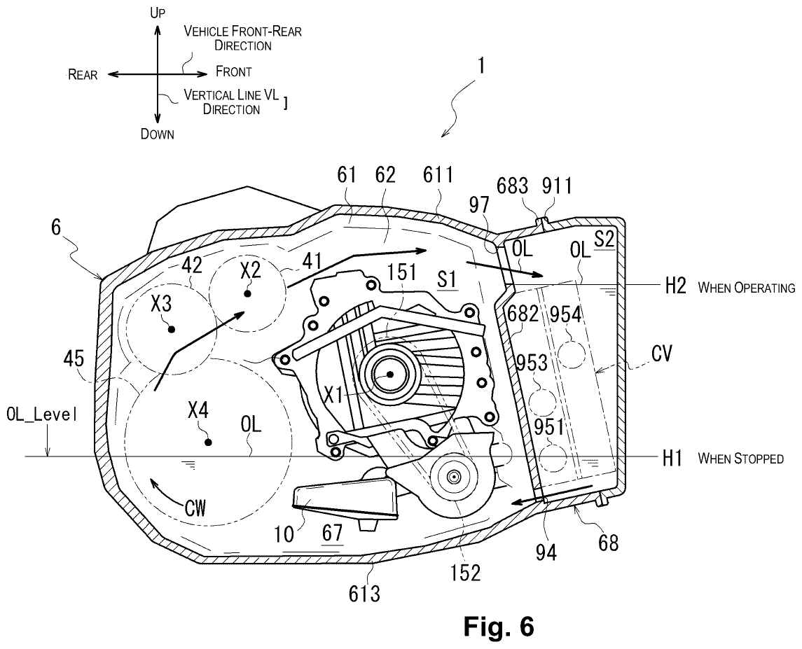

FIG. 6 is a diagram illustrating the movement of the oil OL during operation of the power transmission device 1 and the height of the oil OL collected in the second chamber S2.

As shown in FIG. 6, in the case 6, the oil OL used for the operation of the power transmission device 1 and lubrication of the components of the power transmission device 1 is collected in the housing section 67 located at the bottom of the first chamber S1.

During operation of the power transmission device 1, the oil OL scooped up by the rotating bodies (such as the final gear 45) inside the first chamber S1 flows into the second chamber S2 through the opening 97.

Therefore, the oil OL flowing into the second chamber S2 from the opening 97 and the oil OL discharged from the control valve CV are collected in the second chamber S2. The oil OL in the second chamber S2 is returned to the first chamber S1 through the communication section 94 provided at the bottom of the second chamber S2.

Here, the opening diameter of the communication section 94 is set so that during the operation of the power transmission device 1, the oil OL in the second chamber S2 is collected and the oil OL in the first chamber S1 is the minimum amount necessary for lubricating the rotating bodies.

Therefore, during operation of the power transmission device 1, the oil OL collected in the second chamber S2 reaches a maximum height H2, which reaches the opening 97.

When the power transmission device 1 stops, the inflow of the oil OL into the second chamber S2 from the opening 97 stops. The discharge of oil OL from the control valve CV also stops.

Consequently, the oil OL in the second chamber S2 gradually returns to the first chamber S1 through the communication section 94, and the oil OL in the first chamber S1 and the oil OL in the second chamber S2 eventually reach the same height H1.

In this embodiment, the line pressure regulating valve 951 inside the upright control valve CV is positioned at a height so as to be submerged in the oil OL collected in the second chamber S2 when the power transmission device 1 is stopped.

Therefore, the line pressure regulating valve 951 is positioned below the height H1 of the oil OL when the power transmission device 1 is stopped (oil level OL_Level when the power transmission device 1 is stopped).

When the power transmission device 1 is stopped, the oil OL in the oil pressure control circuit 95 is discharged outside the control valve CV due to gravity.

Therefore, if the line pressure regulating valve 951 is not submerged in the oil OL when the power transmission device 1 is stopped, the oil OL inside the line pressure regulating valve 951 will also drain out.

If the power transmission device 1 is restarted in this state, the oil OL supplied from the oil pump OP must fill the interior of the line pressure regulating valve 951 before line pressure can be supplied to the downstream pressure regulating valves (the primary pressure regulating valve 953, the secondary pressure regulating valve 954). In such cases, the supply of operating oil pressure to the variator 3 may be delayed, potentially affecting the responsiveness of the variator 3.

In particular, in low-temperature environments where the oil OL is at 0° C. or below, the volume of the oil OL decreases as the temperature of the oil OL drops, thus lowering the height of the oil OL collected in the housing HS and increasing the viscosity of the oil OL, which reduces the fluidity of the oil OL.

In this embodiment, the line pressure regulating valve 951 is positioned so that the line pressure regulating valve 951 is at least partially and preferably completely submerged in the oil OL collected in the second chamber S2 when the oil OL temperature is low. This prevents significant delays in the supply of oil OL to the pressure regulating valves downstream of the line pressure regulating valve 951 (the primary pressure regulating valve 953, the secondary pressure regulating valve 954) when the power transmission device 1 is restarted, from having been stopped, in a low-temperature environment. Therefore, an improvement in the responsiveness of the power transmission device 1 at the time of restart can be expected.

Furthermore, in this embodiment, the primary pressure regulating valve 953 is positioned such that the primary pressure regulating valve 953 is at least partially and preferably completely submerged in the oil OL collected in the second chamber S2 when the power transmission device 1 is operating.

The primary pressure regulating valve 953 affects the responsiveness when the temporarily stopped vehicle starts moving again.

When the power transmission device 1 is operated, the temperature of the oil OL becomes higher than when the power transmission device 1 is not operating. As the temperature of the oil OL increases, the volume of the oil OL expands and the fluidity of the oil OL increases.

When the fluidity of the oil OL is high, there is a higher likelihood that the oil OL will drain from the oil pressure control circuit 95 during short stops of the vehicle.

As noted above, the primary pressure regulating valve 953 is positioned below the height H2 of the oil OL during operation of the power transmission device 1 (the oil level during operation of the power transmission device 1).

Therefore, even when the oil is hot, the primary pressure regulating valve 953 is positioned at a height so as to be submerged in the oil OL. This can prevent significant delays in the supply of oil OL from the primary pressure regulating valve 953 to the oil chamber of the primary pulley 31 when the moving vehicle restarts after stopping. Therefore, an improvement in the responsiveness of the power transmission device 1 at the time of restart can be expected.

As shown in FIG. 5, the oil OL regulated by the primary pressure regulating valve 953 is supplied to the oil chamber of the primary pulley 31 via the internal oil path 251 in the case.

The oil OL regulated by the secondary pressure regulating valve 954 is supplied to the oil chamber of the secondary pulley 32 via the internal oil path 252.

In this embodiment, a dummy cover 21 that seals the opening of the circumferential wall section 641 (see FIG. 1) is used to provide internal oil paths 251 and 252.

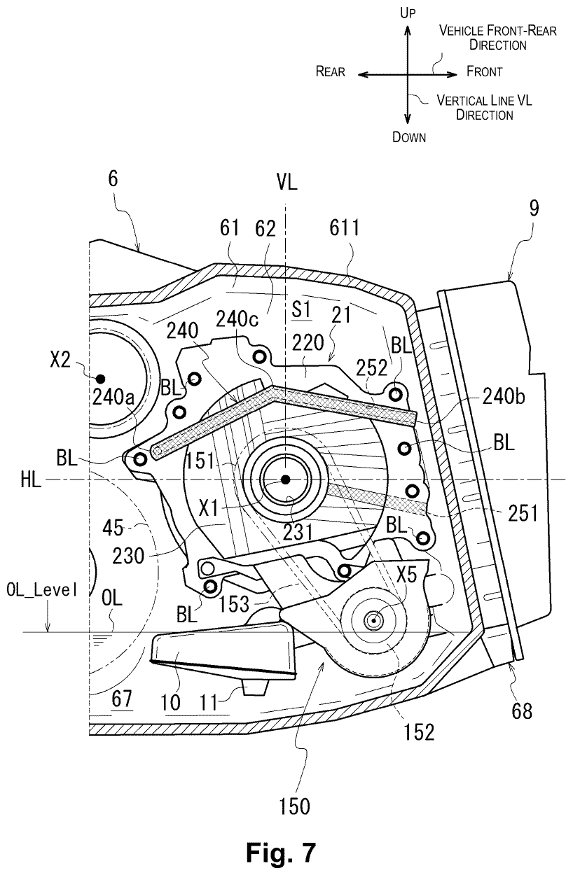

FIG. 7 is a diagram illustrating the dummy cover 21. For ease of explanation, FIG. 7 uses crosshatching to indicate the region where the internal oil path 251 is provided and a rib 240 containing the internal oil path 252.

As shown in FIG. 7, in the power transmission device 1, a power transmission mechanism 150 that transmits rotational drive power to drive the mechanical oil pump MOP is located in a housing section 68 (right side in the diagram) as when viewed from the strainer 10. In FIG. 7, the mechanical oil pump MOP is away from the viewer.

The power transmission mechanism 150 comprises a drive sprocket 151, a driven sprocket 152, and a chain 153.

As shown in FIG. 1, the drive sprocket 151 rotates around the axis of rotation X1 by the rotational drive force input through an impeller sleeve 155 of the torque converter T/C.

The impeller sleeve 155 is externally fitted to the input shaft 20 of the forward-reverse switching mechanism 2. The input shaft 20 is rotatably supported by the dummy cover 21 that seals the opening of the circumferential wall section 641.

The drive sprocket 151 and the impeller sleeve 155 are rotatably supported on the input shaft 20 of the forward-reverse switching mechanism 2.

As shown in FIG. 7, the rotation input to the drive sprocket 151 is transmitted to the driven sprocket 152 via the chain 153. The driven sprocket 152 rotates around the axis X5 as a result of the transmitted rotation. When the driven sprocket 152 rotates, the rotary shaft of the mechanical oil pump MOP connected to the driven sprocket 152 rotates, driving the mechanical oil pump MOP.

This causes the oil OL collected in the lower part of the case 6 to be suctioned through the strainer 10.

As shown in FIG. 2, in the case 6, the circumferential wall section 641 that forms the housing for the forward-reverse switching mechanism 2 is provided with an opening facing toward the viewer (the second cover 8 side). The opening of this circumferential wall section 641 is sealed by the dummy cover 21 (see FIG. 1) that is assembled to the circumferential wall section 641 from the second cover 8 side.

As shown in FIG. 1, the dummy cover 21 is a plate-like member having a predetermined thickness in the direction of the axis of rotation X1. When viewed from the direction of the axis of rotation X1, the dummy cover 21 is provided in a positional relationship overlapping with the forward-reverse switching mechanism 2 and the primary pulley 31. When viewed from the primary pulley 31, the dummy cover 21 is positioned across the torque converter T/C. As shown in FIG. 7, the dummy cover 21 has a peripheral edge 220 and an inner cover section 230 on the inside of the peripheral edge 220.

The peripheral edge 220 abuts against the circumferential wall section 641 (see FIG. 1) on the case 6 side from the direction of the axis of rotation X1. In this state, the peripheral edge 220 is fixed to the circumferential wall section 641 with bolts BL.

The cover section 230 is formed to cover the side surface of the second cover 8 side (toward the viewer) of the forward-reverse switching mechanism 2. A through-hole 231 is provided in the central part of the cover section 230. The input shaft 20 of the forward-reverse switching mechanism 2 passes through the through-hole 231 in the direction of the axis of rotation X1.

Inside the cover section 230, oil paths are provided for distributing the oil OL supplied from the control valve CV side. On the side of the cover section 230 toward the viewer, the part where the oil paths are provided bulges toward the viewer.

An internal oil path 251 is provided inside the region marked with crosshatching in the diagram. In the dummy cover 21, the case internal oil path 251 is located in the region below the horizontal line HL that passes through the axis of rotation X1 and toward the front of the vehicle from the vertical line VL that passes through the axis of rotation X1.

The case internal oil path 251 extends toward the axis of rotation X1 from the outer circumference of the peripheral edge 220 to the through-hole 231. The case internal oil path 251 connects the outlet port of the primary pressure regulating valve 953 and the axial oil path of the primary pulley 31.

Therefore, the operating oil (oil pressure) supplied from the primary pressure regulating valve 953 is supplied to the oil chamber of the primary pulley 31 through the internal oil path 251.

A rib 240 that contains an internal oil path (the case internal oil path 252) is provided above the horizontal line HL in the vertical line VL direction.

The rib 240 bulges outwardly toward the viewer farther than the peripheral edge 220 and the cover section 230. The rib 240 is provided within a range that crosses above the through-hole 231 in the horizontal line HL direction.

The rib 240 is inclined such that the side toward the rear of the vehicle (left side in the diagram) decreases in height in the vertical line VL direction from the boundary part 240c as it moves toward the rear of the vehicle.

The rib 240 is inclined such that the side toward the rear of the vehicle decreases in height in the vertical line VL direction from the boundary part 240c as it moves toward an end 240b toward the front of the vehicle.

When viewed from the direction of the axis of rotation X1, the boundary part 240c of the rib 240 is located near the vertical line VL that passes through the axis of rotation X1. The rib 240 is provided in a bent shape with the boundary part 240c positioned at the topmost side.

The drive sprocket 151 of the power transmission mechanism 150 is located below the rib 240 in the vertical line VL direction. The rib 240 crosses the vertical line VL from the front side to the rear side of the vehicle, while bypassing the drive sprocket 151 thereabove.

The vehicle front end 240b of the rib 240 reaches the outer circumference of the peripheral edge 220. The case internal oil path 252 inside the rib 240 connects to the outlet port of the secondary pressure regulating valve 954.

The vehicle rear end 240a of the rib 240 is located on the peripheral edge 220. The end 240a of the case internal oil path 252 inside the rib 240 opens in the surface of the peripheral edge 220 away from the viewer.

As shown in FIG. 2, in the circumferential wall section 641 on which the dummy cover 21 is mounted, an oil hole 641a opens at a position overlapping with the end 240a when viewed from the direction of the axis of rotation X1.

The oil hole 641a extends inside the circumferential wall section 641 toward the secondary pulley 32 (toward the viewer) and connects to the oil chamber of the secondary pulley 32. Therefore, the case internal oil path 252 connects the outlet port of the secondary pressure regulating valve 954 and the oil chamber on the secondary pulley 32 side.

Thus, the operating oil (oil pressure) supplied from the secondary pressure regulating valve 954 is supplied to the oil chamber of the secondary pulley 32 through the internal oil path 252.

As shown in FIG. 1, the drive sprocket 151 is located toward the torque converter T/C when viewed from the dummy cover 21. The drive sprocket 151 is positioned in the gap between the dummy cover 21 and the torque converter T/C.

The drive sprocket 151 has a thickness in the direction of the axis of rotation X1. As shown in FIG. 7, there is extra space above the drive sprocket 151. In this embodiment, the rib 240 is provided in the space above the drive sprocket 151. The rib 240 bulges toward the side of the torque converter T/C by an amount approximately equivalent to the thickness of the drive sprocket 151 in the direction of the axis of rotation X1. Therefore, even if the rib 240 is provided, the power transmission device 1 does not increase in size in the direction of the axis of rotation X1 due to the rib 240 being provided.

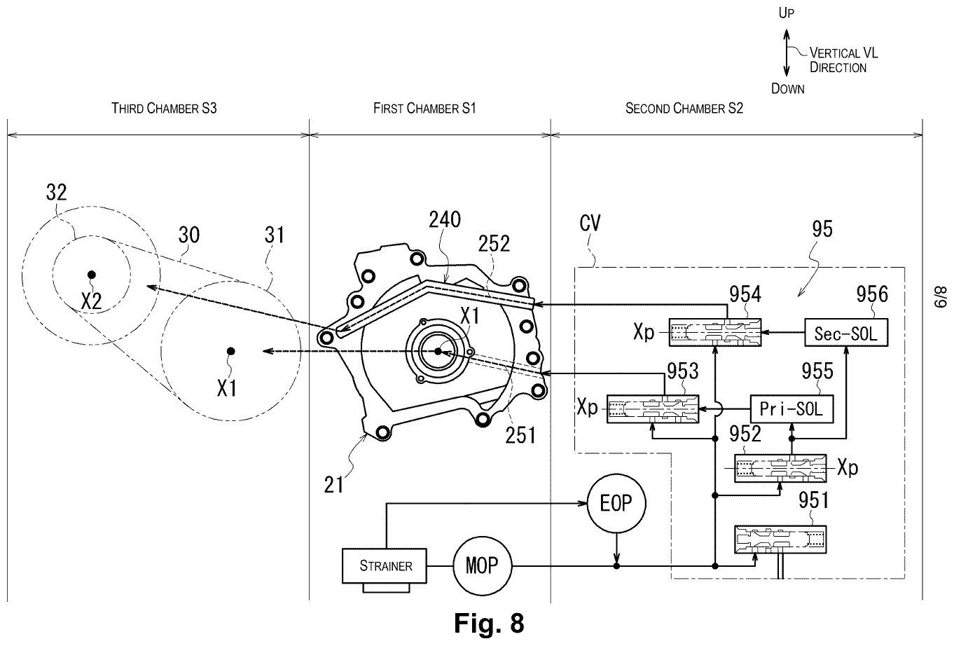

FIG. 8 is a diagram illustrating the positional relationship between the case internal oil paths 251, 252 and the primary pressure regulating valve 953 and the secondary pressure regulating valve 954. FIG. 8 shows that the vertical relationship of the internal oil paths 251, 252 inside the first chamber S1, the vertical relationship of the primary pressure regulating valve 953 and the secondary pressure regulating valve 954 inside the second chamber S2, and the vertical relationship of the primary pulley 31 and the secondary pulley 32 inside the third chamber are aligned.

As shown in FIG. 8, the control valve CV positioned in the second chamber S2 is arranged upright such that the primary pressure regulating valve 953 is located below the secondary pressure regulating valve 954 in the direction of the vertical line VL.

Inside the third chamber S3, the primary pulley 31 is positioned below the secondary pulley 32 in the direction of the vertical line VL.

In this embodiment, the case internal oil path 251, which connects the oil chamber of the primary pulley 31 and the primary pressure regulating valve 953, and the case internal oil path 252, which connects the oil chamber of the secondary pulley 32 and the secondary pressure regulating valve 954, are provided using the dummy cover 21.

The internal oil path 251 is an existing oil path provided inside the dummy cover 21. The internal oil path 252 is an oil path provided inside the rib 240 attached to the dummy cover 21.

In the case of the existing control valve CV provided at the lower opening of the housing HS, the control valve CV is located directly beneath the primary pulley 31 and the secondary pulley 32. There are no other elements between the primary pulley 31, the secondary pulley 32, and the control valve CV that would necessitate rerouting the oil path.

Therefore, by providing an oil path upwards from the control valve CV, it is possible to connect the control valve CV and the oil chambers of the pulleys (the primary pulley 31, the secondary pulley 32) by the shortest distance.

In contrast, in the case of the power transmission device 1 according to this embodiment, as shown in FIG. 3, the primary pulley 31, the oil filter 69, and the opening 620 are positioned between the secondary pulley 32 and the control valve CV. Therefore, there is no room to provide the internal oil path 252, which connects the oil chamber of the secondary pulley 32 and the control valve CV, by the shortest distance in a partition section 62 that supports the secondary pulley 32.

Any oil path provided in the partition section 62 would need to significantly bypass the primary pulley 31 therebelow (below in FIG. 3).

Here, the case internal oil path 251 connecting the control valve CV and the oil chamber of the primary pulley 31 is provided in the dummy cover 21. As shown in FIG. 1, in the dummy cover 21, there is extra space on the outer diameter side of the drive sprocket 151, which is located on the side of the dummy cover 21.

In this embodiment, the case internal oil path 252 is provided in the rib 240 that protrudes from the dummy cover 21 toward the outer diameter side of the drive sprocket 151.

The rib 240 is provided to fit inside the gap in the direction of the axis of rotation X1 where the drive sprocket 151 is provided. Therefore, the rib 240, which contains the case internal oil path 252, prevents the power transmission device 1 from increasing in size in the radial direction.

Further, as shown in FIG. 8, the case internal oil path 252 is positioned above the internal oil path 251 in the vertical line VL direction, imitating the vertical relationship between the primary pulley 31 and the secondary pulley 32, and the vertical relationship between the primary pressure regulating valve 953 and the secondary pressure regulating valve 954.

As a result, inside the case 6, the case internal oil path 252 and the case internal oil path 251 are provided without intersecting each other when viewed from the direction of the axis of rotation X1.

When viewed from the direction of the axis of rotation X1, the case internal oil path 252 crosses the forward-reverse switching mechanism 2 and the side of the primary pulley 31 in the vehicle front-rear direction. Therefore, the case internal oil path 252, which connects the secondary pulley 32 and the secondary pressure regulating valve 954, can be provided by the shortest distance.

This makes it possible to reduce the degree of complexity in the routing, or arrangement, of the case internal oil paths 251 and 252, and to shorten the lengths of the case internal oil paths 251 and 252. As a result, the oil OL can be smoothly supplied to the oil chamber of the primary pulley 31 and the oil chamber of the secondary pulley 32. This enables smooth changes in the winding radius of the belt 30 on the primary pulley 31 and the secondary pulley 32, improving the shift responsiveness in the variator 3.

As described above, the power transmission device 1 according to this embodiment has the following configuration.
(1) The power transmission device 1 comprises
   the variator 3 with the primary pulley 31 and the secondary pulley 32, and
   the control valve CV with the oil pressure control circuit 95 that supplies the operating oil OL to the primary pulley 31 and the secondary pulley 32.

The control valve CV has multiple pressure regulating valves with valve bodies (spool valves) that move in the horizontal line HL direction.

The control valve CV is arranged upright, aligning the pressure regulating valves in the vertical line VL direction (vertical direction).

The axis of rotation X2 of the secondary pulley 32 is positioned above the axis of rotation X1 of the primary pulley 31 in the vertical direction.

The secondary pressure regulating valve 954 (second pressure regulating valve), which adjusts the supply pressure to the secondary pulley 32, is positioned above the primary pressure regulating valve 953 (first pressure regulating valve), which adjusts the supply pressure to the primary pulley 31, in the vertical direction.

With this configuration, the arrangement of the axis of rotation X2 of the secondary pulley 32 and the axis of rotation X1 of the primary pulley 31 in the vertical direction and the arrangement of the secondary pressure regulating valve 954 (second pressure regulating valve) and the primary pressure regulating valve 953 (first pressure regulating valve) in the vertical direction are aligned. This allows for the case internal oil path 252 (second oil path), which supplies oil from the secondary pressure regulating valve 954 to the secondary pulley 32, and the case internal oil path 251 (first oil path), which supplies oil from the primary pressure regulating valve 953 to the primary pulley 31, to be provided without intersecting when viewed from the direction of the axis of rotation X1.

Consequently, the degree of complexity of the oil path layout (arrangement) can be reduced, and the case internal oil paths 251, 252 can each be shortened. As a result, the oil OL can be smoothly supplied to the oil chambers of the primary pulley 31 and the secondary pulley 32. This enables smooth changes in the winding radius of the belt 30 on the primary pulley 31 and the secondary pulley 32, improving shift responsiveness in the variator 3.

Note that the embodiment described a case where the valve bodies (spool valves) of the pressure regulating valves move in the horizontal line HL direction, however, the valve bodies are not limited to moving strictly along the horizontal line HL, and the valve bodies may simply move laterally relative to the vehicle.
(2) As viewed from the direction of the axis of rotation X1, the primary pulley 31 is positioned between the secondary pulley 32 and the control valve CV.

The case internal oil path 252 for the secondary pulley 32 is provided in the dummy cover 21, which is a separate wall section from the partition section 62 that is a supporting wall for the primary pulley 31.

The dummy cover 21 is in a positional relationship overlapping with the primary pulley 31 when viewed from the direction of the axis of rotation X1.

The oil OL regulated by the secondary pressure regulating valve 954 is supplied to the oil chamber of the secondary pulley 32 via the case internal oil path 252.

With this configuration, the dummy cover 21 is positioned away from the partition section 62 in the direction of the axis of rotation X1, and when viewed from the direction of the axis of rotation X1, the dummy cover 21 is positioned overlapping with the partition section 62 and the primary pulley 31.

This allows the case internal oil path 252 to be provided through the side of the primary pulley 31 (the side toward the torque converter T/C) in the direction of the axis of rotation X1.

In this case, compared to when the case internal oil path is provided by bypassing the outer diameter side of the primary pulley 31 (such as the lower side in FIG. 3), the length of the internal oil path 252 can be shortened. This reduction in the total length of the case internal oil path allows for smoother supply of the oil OL to the oil chamber of the secondary pulley 32, thus improving the shift responsiveness in the variator 3.
(3) In the dummy cover 21, the thickness in the direction of the axis of rotation X1 of the region of the rib 240 where the case internal oil path 252 is provided is thicker than the thickness in the direction of the axis of rotation X1 of other regions.

The case internal oil path 252 is provided inside the rib 240 attached to the dummy cover 21. The dummy cover 21 is such that the thickness in the direction of the axis of rotation X1 where the rib 240 is attached becomes thicker by the thickness of the rib 240. In the dummy cover 21, the rib 240 is formed as a protrusion extending in the direction of the axis of rotation X.

Instead of increasing the overall thickness of the dummy cover 21, only the thickness of the parts necessary for the arrangement of the case internal oil path 252 is increased, making it possible to suitably prevent an increase in the overall weight of the dummy cover 21.
(4) The oil pressure control circuit 95 includes the line pressure regulating valve 951 that regulates the line pressure from the primary pressure supplied by the oil pump OP.

In the control valve CV, the line pressure regulating valve 951 is located below the primary pressure regulating valve 953 in the vertical line VL direction (vertical direction).

When the control valve CV is arranged upright in the second chamber S2 that houses the control valve CV, the line pressure regulating valve 951, the primary pressure regulating valve 953, and the secondary pressure regulating valve 954 are arranged in this order from the bottom up. Therefore, the line pressure regulating valve 951 is positioned at the very bottom.

When the power transmission device 1 is not operating, the oil OL is not supplied to the control valve CV, so the oil OL inside the control valve CV is gradually discharged to the outside of the control valve CV. As a result, the oil OL drains from the oil pressure control circuit 95 inside the control valve CV.

When the power transmission device 1 is restarted, the oil supplied to the control valve CV fills the oil pressure control circuit 95 with oil OL before being supplied to destinations of the oil OL such as the primary pulley 31 and the secondary pulley 32.

Therefore, if a significant amount of oil OL has drained from the oil pressure control circuit 95, the responsiveness of the variator 3 is adversely affected.

The line pressure regulating valve 951 is the first pressure regulating valve that adjusts the pressure of the oil OL supplied from the oil pump and has a significant impact on responsiveness when the power transmission device 1 is restarted. Therefore, positioning the line pressure regulating valve 951 at the very bottom makes it possible to submerge the line pressure regulating valve 951 in the oil OL collected in the second chamber S2 when the power transmission device 1 is not operating.

This can be expected to improve the responsiveness when the power transmission device 1 is restarted.
(5) The height position of the line pressure regulating valve 951 in the vertical line VL direction (vertical direction) is
   set so that at least a part of the line pressure regulating valve 951 is submerged in the oil OL collected in the second chamber S2 when the power transmission device 1 is not operating.

Setting the height position of the line pressure regulating valve 951 based on the height of the oil OL collected in the second chamber S2 when the power transmission device 1 is not operating ensures that there is no significant delay in the supply of oil OL from the line pressure regulating valve 951 to the primary pressure regulating valve 953 and the secondary pressure regulating valve 954 when the power transmission device 1 is restarted.

In particular, in environments at or below 0° C., as the temperature of the oil OL decreases, the volume of the oil OL decreases, causing the height of the oil OL collected in the housing HS (second chamber S2) to drop and the viscosity of the oil OL to increase, thereby reducing the fluidity of the oil OL.

With this configuration, when the power transmission device 1 is restarted after being stopped in a low-temperature environment, the potential for significant delays in the supply of the oil OL from the line pressure regulating valve 951 to the primary pressure regulating valve 953 and the secondary pressure regulating valve 954 can be reduced.

This can lead to improved responsiveness when restarting the power transmission device 1.
(6) The height position of the primary pressure regulating valve 953 (first pressure regulating valve) in the vertical line VL direction (vertical direction) is set
   to a height position so that at least part of the primary pressure regulating valve 953 is submerged when the temperature of the oil OL collected in the housing HS (second chamber S2) is higher (high temperature) than when the power transmission device 1 is not operating.

When the power transmission device 1 is operating, the temperature of the oil OL increases. As the temperature of the oil OL increases, the volume of the oil OL increases. This results in a decrease in the viscosity of the oil, enhancing the fluidity of the oil OL. Even during short stops of the power transmission device 1, there is a possibility that the oil OL may drain from the oil pressure control circuit 95.

Therefore, setting the height position of the primary pressure regulating valve 953 so that at least a part of the primary pressure regulating valve 953 is submerged in the oil OL collected in the second chamber S2 when the oil OL temperature is high reduces the potential for significant delays in the supply of the oil OL from the line pressure regulating valve 951 and the primary pressure regulating valve 953 when the power transmission device 1 is restarted after having been stopped in a high-temperature environment. Improved responsiveness when restarting the power transmission device 1 can thereby be expected.
(i) The case internal oil path 251 for the primary pulley 31 (first oil path) is provided using the thickness of the dummy cover 21.

When both the internal oil path 251 (first oil path) and the case internal oil path 252 (second oil path) are provided using the thickness of the dummy cover 21, it is necessary to increase the thickness of the dummy cover 21 to enhance the rigidity of the dummy cover 21.

With this configuration, since the case internal oil path 252 is provided inside the rib 240, which is made locally thicker in the dummy cover 21, there is no need to increase the overall thickness of the dummy cover 21. This can suitably prevent the degree of weight increase of the power transmission device 1. Therefore, the fuel efficiency of the vehicle equipped with the power transmission device 1 can be expected to improve.
(ii) The primary pulley 31 is located on one side (the third chamber S3 side) of the partition section 62 (support wall) in the direction of the axis of rotation X1.

On the other side of the partition section 62 (first chamber S1), the power transmission mechanism (forward-reverse switching mechanism 2) is located. The dummy cover 21 is a cover that covers the opening of the circumferential wall section 641, which forms the housing chamber for the forward-reverse switching mechanism 2. Viewed from the direction of the axis of rotation X1, the dummy cover 21 is formed large enough to cover the second cover 8 side of the forward-reverse switching mechanism 2.

The forward-reverse switching mechanism 2 (power transmission mechanism), which transmits the input rotation from the drive source (the engine ENG) to the primary pulley 31, is covered on the side opposite the partition section 62 by the dummy cover 21. This dummy cover 21 is an existing component in the power transmission device 1.

Therefore, by providing the case internal oil path 252 in the existing dummy cover 21, there is no need to separately provide a dedicated wall section inside the housing HS for providing the case internal oil path 252. This can prevent a weight increase in the power transmission device 1 due to an increase in the number of parts.

Additionally, if a wall section is provided separately from the existing dummy cover, the power transmission device 1 increases in size in the direction of the axis of rotation X1. By using the existing dummy cover 21 to provide the internal oil path 252, the power transmission device 1 is suitably prevented from increasing in size in the direction of the axis of rotation X1.
(iii) Viewed from the dummy cover 21, the drive sprocket 151 is provided on the side opposite the primary pulley 31 in the direction of the axis of rotation X1.

The drive sprocket 151 is provided adjacent to the dummy cover 21.

Viewed from the direction of the axis of rotation X1, the case internal oil path 252 is provided the drive sprocket 151 thereabove.

For instance, if the driven sprocket 152 is positioned below the drive sprocket 151, there is extra space above the drive sprocket 151 on the side of the dummy cover 21 in the direction of the axis of rotation X1.

When viewed from the direction of the axis of rotation X1, if the case internal oil path 252 can be provided by bypassing above the drive sprocket 151 and along the outer circumference of the drive sprocket 151, the rib 240 created by the case internal oil path 252 can be provided without interfering with the drive sprocket 151.

In such cases, since the rib 240 is positioned in the open gap on the side of the dummy cover 21, the power transmission device 1 can be suitably prevented from increasing in size in the direction of the axis of rotation X when providing the rib 240.
(iv) Viewed from the direction of the axis of rotation X1, the mechanical oil pump MOP is located below the primary pulley 31 in the vertical direction.

The mechanical oil pump MOP is positioned toward the second chamber S2 in the lower housing section 67 of the case 6.

With this configuration, the length of the oil path 628 (third oil path) supplying oil from the mechanical oil pump MOP to the line pressure regulating valve 951 can be shortened, which can be expected to improve the responsiveness of the power transmission device 1 when restarted.
(v) The second chamber S2 that houses the control valve CV is provided inside the housing HS that houses the power transmission mechanism, separate from the first chamber S1 that houses the power transmission mechanism.

During the operation of the power transmission device 1, the oil OL discharged from the control valve CV is at least collected in the second chamber S2.

The second chamber S2 is formed with a smaller volume than the first chamber S1.

With this configuration, the fluctuation in the height of the oil OL in the second chamber S2 is greater than the fluctuation in the height of the oil OL in the first chamber S1.

Therefore, when the power transmission device 1 is operating, it is possible to ensure that the intended pressure regulating valves (the line pressure regulating valve 951, the primary pressure regulating valve 953) are reliably submerged in the oil OL collected in the second chamber S2.
(vi) The control valve CV is positioned in the second chamber S2 along the direction of the axis of rotation X1 of the primary pulley 31.

With this configuration, the pressure regulating valves of the control valve CV (the line pressure regulating valve 951, the primary pressure regulating valve 953, the secondary pressure regulating valve 954) are arranged along the direction of the axis of rotation X1 of the primary pulley 31.

This allows the second chamber S2 that houses the control valve CV to have a reduced thickness in the radial direction of the axis of rotation X1 of the primary pulley 31, which can suitably prevent an increase in size of the power transmission device 1.

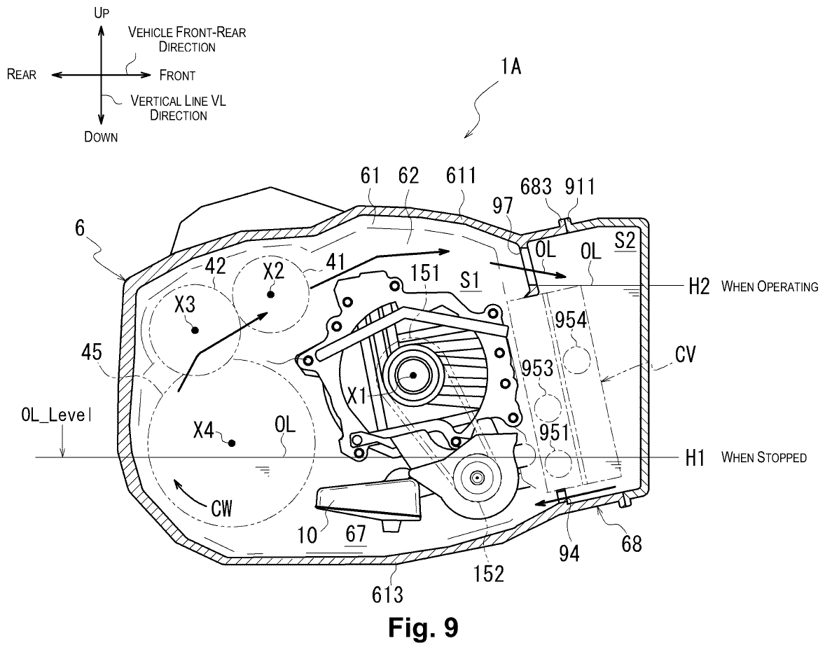

FIG. 9 is a schematic diagram illustrating a modified example of the power transmission device 1A.

In the foregoing embodiment, a case was illustrated in which the first chamber S1 housing the strainer 10 and the second chamber S2 housing the control valve CV are completely separated by the wall section 682 (see FIG. 6).

As shown in FIG. 9, it is also possible for a power transmission device 1A to be configured such that the control valve CV functions as a partition wall separating the first chamber S1 and the second chamber S2.

Even with such a configuration of the power transmission device 1A, it is possible to reduce the complexity of the oil path layout, and an improvement in shift responsiveness in the variator 3 can be expected.

In the foregoing embodiment, a case was illustrated in which the power transmission device 1 transmits the rotation of the engine ENG to the drive wheels WH, WH, but it is also possible for the power transmission device 1 to transmit the rotation of at least one of the engine ENG or the motor (rotary electrical machine) to the drive wheels WH, WH. For example, it is possible to use a single-motor, double-clutch power transmission device (in which the motor is arranged between the engine ENG and the power transmission device, a first clutch is disposed between the engine ENG and the motor, and a second clutch is arranged inside the power transmission device 1).

Further, in the foregoing embodiment, a case was illustrated in which the power transmission device 1 has a shifting function, but it is also possible for the power transmission device simply to reduce speed (or increase speed) and not have a shifting function. If the power transmission device does not have a shifting function and instead reduces and transmits the rotation of the motor to the drive wheels WH, WH, the oil pressure control circuit for supplying the oil OL for cooling the motor and the oil OL for lubricating the reduction mechanism is arranged in the second chamber S2 with the electric oil pump EOP. Further, in the foregoing embodiment, a case was illustrated in which the control unit of the power transmission device 1 was provided with the control valve CV, but if the power transmission device 1 does not have a shifting mechanism and the drive source is a motor (rotary electrical machine) and not the engine ENG, then the control unit may be provided with an inverter or the like for controlling driving of the motor.

Embodiments of the present invention have been described above, but the present invention is not limited only to those aspects shown in the embodiments. The present invention may be modified as deemed appropriate within the scope of the technical concept of the invention.

### EXPLANATION OF THE REFERENCE SYMBOLS

1, 1A Power transmission device; 21 Dummy cover (wall section); 240 Rib; 251 Case internal oil path (first oil path); 252 Case internal oil path (second oil path); 3 Variator; 31 Primary pulley; 32 Secondary pulley; 62 Partition section (support wall); 95 Oil pressure control circuit; 951 Line pressure regulating valve; 953 Primary pressure regulating valve (first pressure regulating valve); 954 Secondary pressure regulating valve (second pressure regulating valve); CV Control valve; OP Oil pump; S2 Second chamber; HS Housing; X1 Axis of rotation; and X2 Axis of rotation.

1. A power transmission device comprising:
a variator having a primary pulley and a secondary pulley; and
a control valve configured to supply a working oil to the primary pulley and the secondary pulley,
wherein the control valve has a plurality of pressure regulating valves with valve bodies that move in a horizontal direction, the pressure regulating valves including a first pressure regulating valve configured to adjust a supply pressure to the primary pully and a second pressure regulating valve configured to adjust a supply pressure to the secondary pully,
the control valve is oriented such that the pressure regulating valves are arranged in a vertical direction,
the an axis of rotation of the secondary pulley is located above an axis of rotation of the primary pulley in the vertical direction, and
the second pressure regulating valve is located above a first pressure regulating valve.

2. The power transmission device as claimed in claim 1, wherein
the primary pulley is located between the secondary pully and the control valve,
a second oil path for the secondary pulley is provided to a separate wall section from a support wall of the primary pulley, and
the wall section is provided in a positional relationship overlapping with the primary pulley viewed from a direction of the axis of rotation.

3. The power transmission device as claimed in claim 2, wherein
the wall section is thicker in the direction of the axis of rotation in a region where the second oil path is provided than in the direction of the axis of rotation in other regions.

4. The power transmission device as claimed in claim 1, further comprising
a line pressure regulating valve configured to regulate a line pressure from a primary pressure supplied from an oil pump
in the control valve, the line pressure regulating valve is located below the first pressure regulating valve in the vertical direction.

5. The power transmission device as claimed in claim 4, wherein
a height position of the line pressure regulating valve is set to a height position such that at least a part of the line pressure regulating valve is submerged in oil collected in a case when the power transmission device is not operating.

6. The power transmission device as claimed in claim 5, wherein
a height position of the first pressure regulating valve is set to a height position such that at least a part of the first pressure regulating valve is submerged when the oil collected in the case is at a higher temperature than when the power transmission device is not operating.

1. A power transmission device comprising:
a variator having a primary pulley and a secondary pulley; and
a control valve that supplies a working oil to the primary pulley and the secondary pulley,
wherein the control valve has multiple pressure regulating valves with valve bodies that move in a horizontal direction,
the control valve is disposed oriented such that the pressure regulating valves are arranged in a vertical direction,
the axis of rotation of the secondary pulley is located above the axis of rotation of the primary pulley in the vertical direction, and
a second pressure regulating valve that adjusts supply pressure to the secondary pulley is located above a first pressure regulating valve that adjusts supply pressure to the primary pulley in the vertical direction.

2. The power transmission device as claimed in claim 1, wherein
the primary pulley is located between the secondary pully and the control valve,
a second oil path for the secondary pulley is provided to a separate wall section from a support wall of the primary pulley, and
the wall section is provided in a positional relationship overlapping with the primary pulley viewed from the direction of the axis of rotation.

3. The power transmission device as claimed in claim 2, wherein
the wall section is thicker in the direction of the axis of rotation in a region where the second oil path is provided than in the direction of the axis of rotation in other regions.

4. The power transmission device as claimed in any one of claims 1 to 3, wherein
a line pressure regulating valve that regulates line pressure from a primary pressure supplied from an oil pump is provided,
in the control valve, the line pressure regulating valve is located below the first pressure regulating valve in the vertical direction.

5. The power transmission device as claimed in claim 4, wherein
a height position of the line pressure regulating valve is set to a height position such that at least a part of the line pressure regulating valve is submerged in oil collected in a case when the power transmission device is not operating.

6. The power transmission device as claimed in claim 5, wherein
a height position of the first pressure regulating valve
is set to a height position such that at least a part of the first pressure regulating valve is submerged when the oil collected in the case is at a higher temperature than when the power transmission device is not operating.
